(19) United States
(12) Patent Application Publication
(10) Pub. No.: US 2026/0056005 A1
(43) Pub. Date: Feb. 26, 2026

(54) Use of Independent Component Analysis (ICA), a powerful Machine Learning (ML) algorithm, for composite Pulsed Eddy Current (PEC) signal deconvolution, feature extraction and thickness quantification of concentric Multi-barrier tubulars in oil/gas wells or any similar scenario with concentric pipes to be evaluated

(71) Applicant: Kenechukwu Chinedu Nduagubam, Airdrie (CA)

(72) Inventor: Kenechukwu Chinedu Nduagubam, Airdrie (CA)

(21) Appl. No.: 19/278,783

(22) Filed: Jul. 24, 2025

Related U.S. Application Data
(60) Provisional application No. 63/686,781, filed on Aug. 24, 2024.

(30) Foreign Application Priority Data
Aug. 21, 2024 (CA) 3252769

(51) Int. Cl. G01B 7/06

(52) U.S. Cl. CPC G01B 7/06

(57) ABSTRACT

Traditionally, feature extraction and thickness quantification of Pulsed eddy current (PEC) composite signals from multiple concentric pipes in oil and gas wells or similar, have been approached via pre-built frequency domain inversion models that do not utilize in-situ data and are subject to many unknown variables. We apply independent component analysis (ICA) with known applications in other areas including facial feature extraction, in a novel fashion to determine from in-situ data, the original independent PEC signals corresponding to each pipe, from their composite signal, hence allowing the thickness of each pipe to be reliably quantified. Since ICA is unsupervised, no prior modelling with synthetic or out-of-sample data is required, rather in-situ data is utilized. The results are consistent across logging tool manufacturers as prior knowledge of each tool sensor/physics is not required.

1. The use of Pulsed Eddy Current (PEC) techniques for thickness/corrosion evaluation of multiple concentric Ferromagnetic pipes has been in place within the oil and gas industry (possibly others) for quite some time now. While there have been continuous improvements in sensor design and data quality improvements over the years, the key challenge has always been around the processing of the data for reliable feature extraction and quantification of thickness/metal loss.

There is a number of reasons why this is challenging:
a. The signal measured by the sensors are very small, prone to noise (conveyance yo-yo etc) and with a very poor Signal to Noise ratio (SNR).
b. The signals span many orders of magnitude (making it imperative in my invention to take certain processing steps like standardization explained below)
c. The signal is a composite one (a complex convolution of signals where each original (unmixed) signal is a representation of the features of each individual concentric pipe.
d. Inconsistencies in the results of the processed data from one logging tool/sensor manufacturer/log analyst to another for the same data. (No unified, independent approach)
e. The signature of the signal varies with the pipe's electrical and magnetic (EM) properties even for the same dimensions and thickness. It is impossible to build sensor response models that reliably generalize well across different possible combinations of EM properties. This is the current approach prior to this invention.
f. Processing PEC data before this invention necessarily required prior knowledge of each tool's specific sensor physics/response/model, as well as the EM properties of downhole pipes which unfortunately, are typically unknown.

2. The first step in the data processing of pulsed eddy current signals in multiple pipes is to decompose this composite signal reliably into independent signals where each signal is a faithful representation of the signal response from each of the pipes under investigation.

3. Independent Component analysis (ICA) is a well-known unsupervised Machine Learning Algorithm which has been used widely for other applications such as facial recognition, speech/music separation (the cocktail party problem) or blind source separation but has never been applied to pulsed eddy current signal decomposition.

4. The terms “Blind source separation” and ‘unsupervised” refer to the fact that the algorithm needs not have any prior knowledge of how the original signals were combined (no prior knowledge of sensor model/behavior etc) but will figure it out by maximizing Kurtosis (the fourth order moment) which is a measure of non-gaussianity of each original signal (sources). Inherently therefore it is tool/manufacturer/sensor agnostic and achieves a consistent, reliable result irrespective of the tool manufacturer/nuances in sensor design as it does not need to know much if at all, about the sensors design or modelled response.

5. Under the hood, ICA uses a set of data science steps to determine the unmixing matrix that needs to be applied to the composite signal to achieve the independent matrix signals.

6. According to the central limit theorem, a combination of many non-gaussian uncorrelated signals will tend towards gaussian. Therefore, the more independent a signal is, the less gaussian it is.

### MATHEMATICAL DETAILS

1. Each measurement sample in time of the PEC signal at each depth is represented as a Matrix or 2D-Array, X (the k×m composite or ‘observation’ matrix, where m is the number of depth rows investigated, and k is the number of time domain measurement samples). ICA assumes that the composite signal is a linear combination of some independent signals (sources) and is separable if the original signals are statistically independent and non-Gaussian. The former requirement is more stringent and would depend on pipe responses not appearing too similar or dependent. The latter requirement is typically easily met in PEC signals. To mitigate non-linearities, ICA is applied over multiple batches of short intervals of time (zoning) across the sampled time domain measurements.
2. There is some mixing matrix, A, such that X=A Z where Z is the matrix of the initially unknown original independent signals. Y=WX where W is the de-mixing matrix and the whole essence of the ICA is to find the de-mixing matrix W such that Y approximates Z. There are usually more observations than there are sources, and the result is over-determined)
3. The number of sources (number of concentric pipes) present is known in advance, so this removes the additional complexity of finding the optimal number of sources.
4. The key challenge with ICA that distinguishes it from just solving the usual simple matrix equation is that both W and Z (or Y) are unknown. (Only the observation (composite) matrix, X is initially known)

### STEPS

1. Linearize:

Take a natural log of each observed signal (Each column of the observed signal Matrix, X) to facilitate linearity which is important for ICA:

$$X ⟵ ln ( X )$$

2. Centre:

The data is centered by subtracting the mean of each observed signal from itself such that the resulting mean is zero.

X<-----X−31 E[X] (where ‘E’ stands for expectation)
3. Whiten:

Compute the Co-variance Matrix, C=E[X X^{T}] of the resulting centered data from (1).

Compute the Singular Value Decomposition (SVD) of C

(Actually, this will be the Eigenvalue Decomposition since C is necessarily a square Matrix)

$$C = V \sum {V}^{T}$$

The whitening matrix is defined by U=Σ⁻¹/2 V^{T}

X<-----UX; resulting X is now linearized, centered and whitened whitening decorrelates and standardizes X such that the independent components are uncorrelated vectors that lie in unit Rⁿ space (with variance=1). Standardization ensures that larger signals such as responses from smaller inner pipes do not overshadow those from outer larger pipes and affect the feature extraction.
4. Maximize non Gaussianity/Kurtosis using FastICA:

Using the non-linear hyberbolic function g=tanh(f) and its derivate g′=1−tanh2(f) Initialize a k x 1 weight vector W where k is the number of time domain samples in the composite data. Iteratively find the optimal weight vector W⁺ such that the non-gaussianity of W^{+T}X is maximized:

$${W}^{+} ⟵ E [ Xg ( {W}^{T} X ) ] - E [ {g}^{′} ( {W}^{T} X ) ] W$$

$${W}^{+} ⟵ W / \vert W \vert$$

Until convergence. (Little to no change in W or based on some predetermined threshold).

The resulting W^{+T}X at convergence is just one unit of extracted original independent source. Additional components are extracted by orthogonalizing subsequent weight vectors, Wp, with respect to the previously found vectors after each estimation step above to avoid converging to the same vector:

$$Wp ⟵ Wp - {\sum }_{j = 1}^{p - 1} ( {W}_{p}^{T} {W}_{j} ) {w}_{j}$$

Then normalize again:

$$Wp ⟵ Wp / \vert Wp \vert$$

5. Each independent source can then be used to convert into Engineering units by comparing the response from a reference section of the pipe of known (or estimable) condition/Wall loss. The thickness is well known to be some function of the decay rate. Once the composite signal is decomposed, the individual pipe wall losses can be computed by taking a few points of good pipe section of the well for each pipe, building a matrix/vector of decay rates and corresponding Engineering units, and computing a representative function.
6. The entire approach is dynamic, is strictly data driven, based on in-situ observed pipe responses and not a pre-modelled approach.

### DESCRIPTION OF DRAWINGS

FIG. 1 Shows an API log plot (Well depth versus PEC signal amplitude in milli volts or some scaled equivalent) of the original PEC signal (left of the track with the intensity MAP plot (PEC-AXL)) and the corresponding deconvolved signals (right of the intensity MAP plot), from three concentric pipes at different time instants. The casing collars can be seen to be separated on the deconvolved curves such that each independent signal (each deconvolved curve) represents the response from only one individual pipe at a given instant of time.

FIG. 2 Shows the Graphical User Interface using either the FastICA library from scikit-learn or a native G Programming approach, with the necessary parameters/arguments required to achieve decomposition as well as the start and floor curves for zoning.

FIG. 3 Shows a LabVIEW graphical code equivalent for the ICA-based decomposition algorithm highlighting important steps such as linearization, and zoning to further address non-linearity.

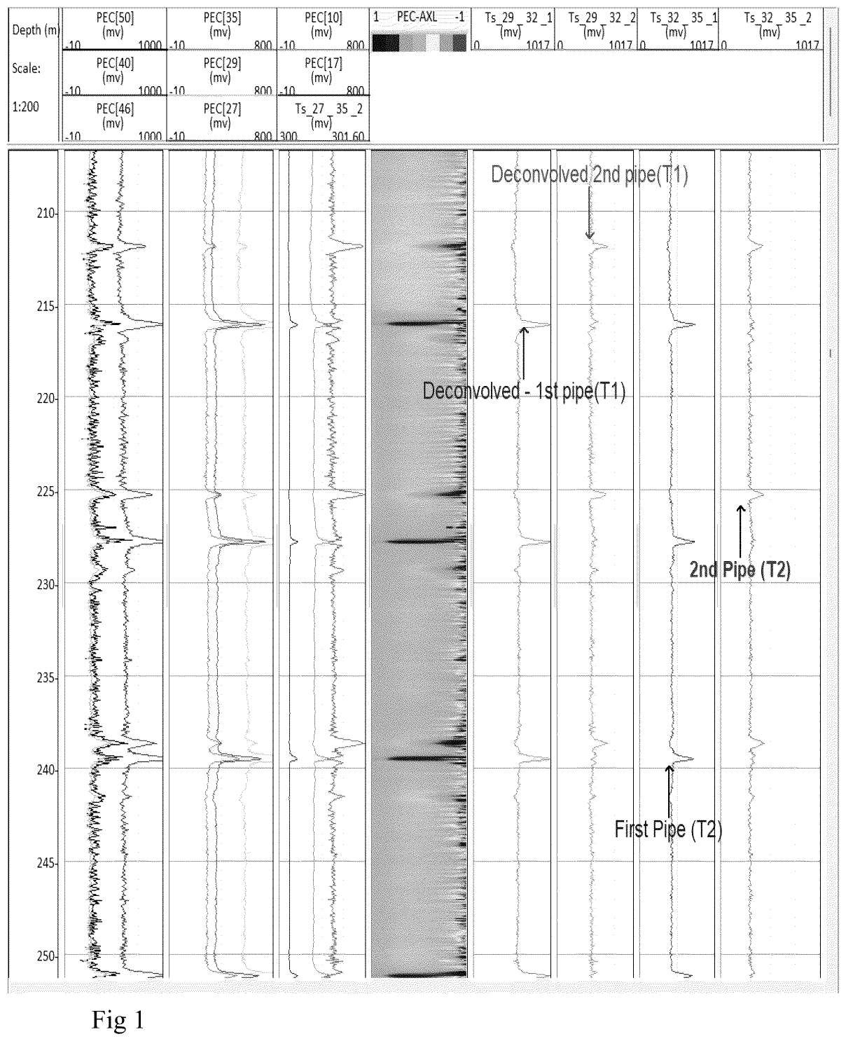

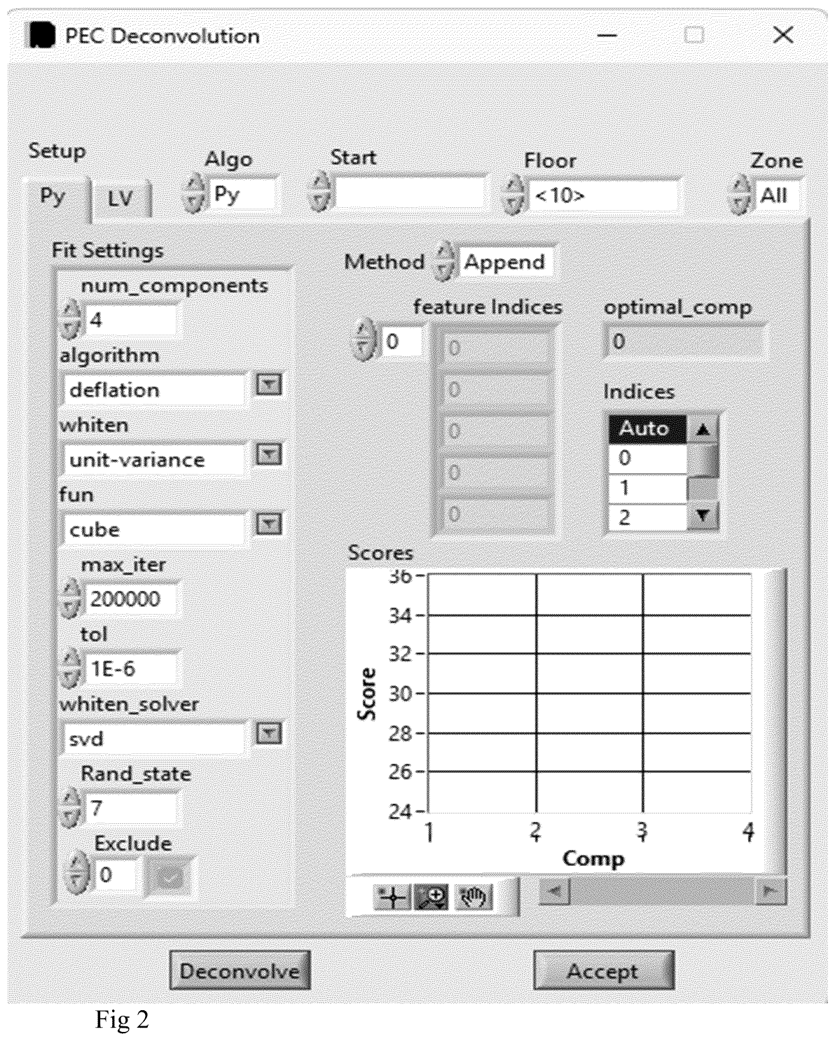

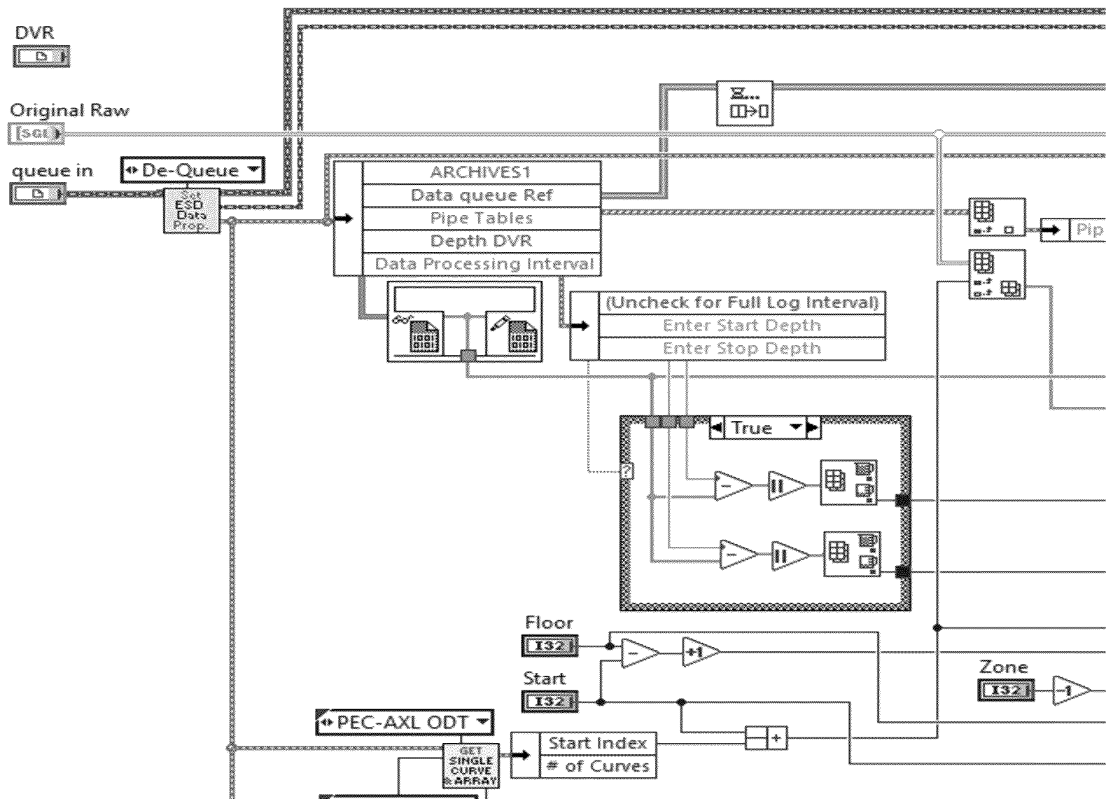

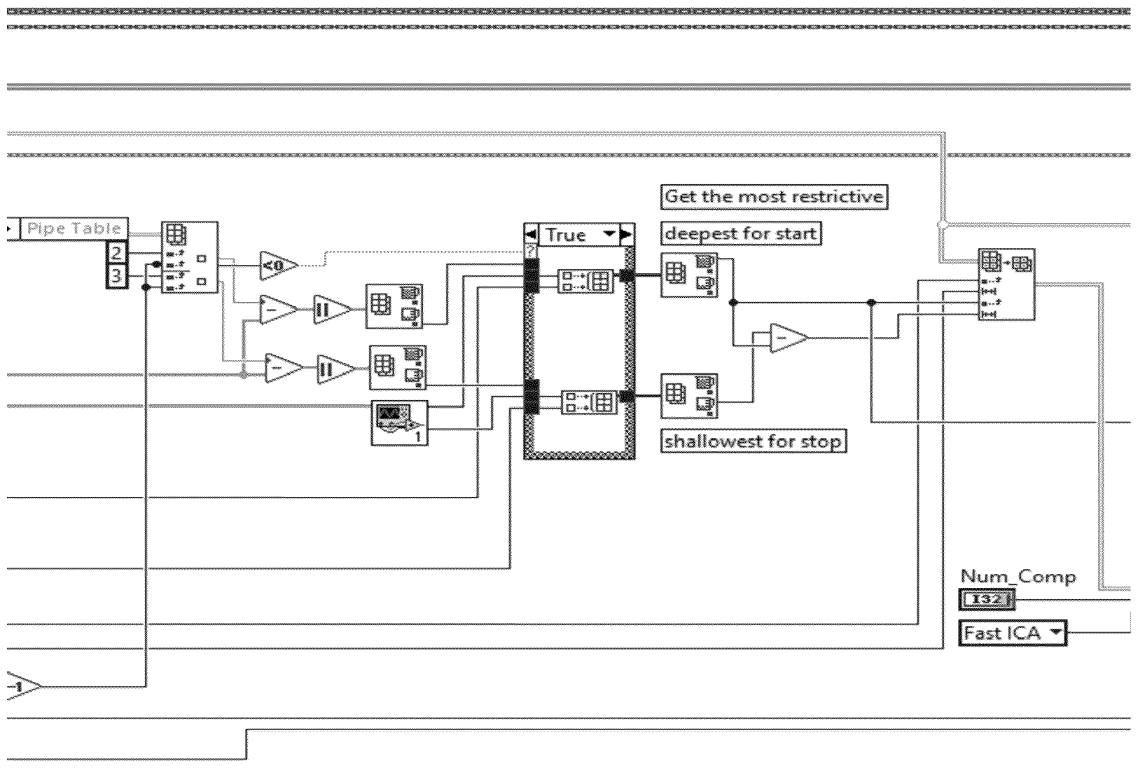

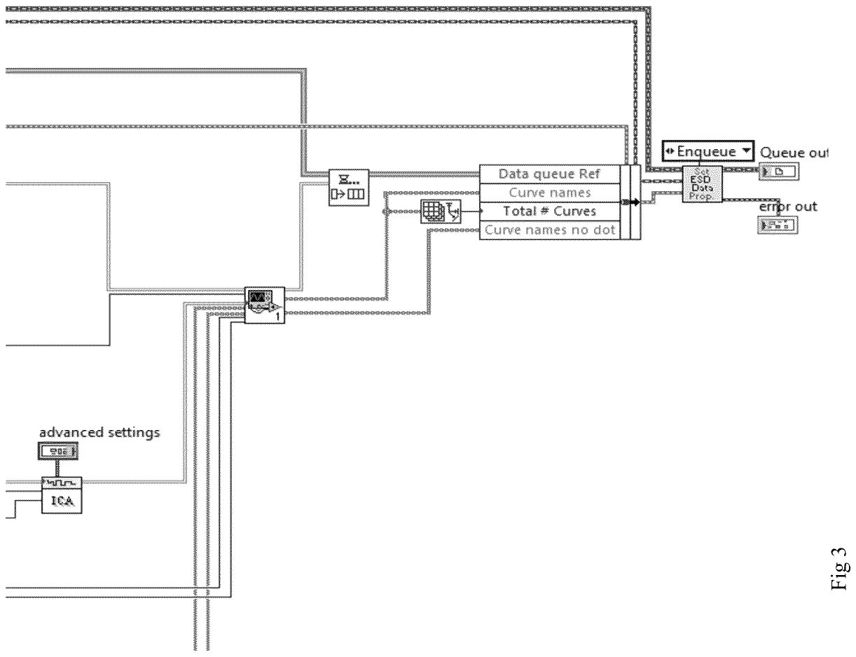

1. This is the first time the independent component Analysis (ICA) approach is used for deconvolution/decomposition of composite Pulsed Eddy Current (PEC) signals in the context of multi-barrier thickness feature extraction and thickness quantification of multiple concentric pipes. ICA is applied over a range of two different time intervals of the raw PEC signal and the resulting pairs of original pipe response decay signals are used to determine the decay rate which is a function of thickness/cross-sectional area.

2. This allows analysis of PEC signals and thickness quantification from any Multi-barrier thickness tool manufacturer irrespective of variations in the tool properties (coil size, core type etc). The extraction process also works regardless of whether the raw PEC signal has been altered with gain factors to allow for quantification over an often-wide range of PEC floating point signal values with a representable integer range of −32767 to 32768 (typically signed 16 bit).
